(19) United States
(12) Patent Application Publication
(10) Pub. No.: US 2014/0079266 A1
(43) Pub. Date: Mar. 20, 2014

(54) MATING PORTABLE SPEAKER WITH PROTECTED CONNECTOR

(71) Applicants: Aaron Michael Szymanski, Mississauga (CA); Brian Dennis Paschke, Mississauga (CA); Di Tao, Toronto (CA); Jamaal Peele, Mississauga (CA); Todd Andrew Wood, Toronto (CA)

(72) Inventors: Aaron Michael Szymanski, Mississauga (CA); Brian Dennis Paschke, Mississauga (CA); Di Tao, Toronto (CA); Jamaal Peele, Mississauga (CA); Todd Andrew Wood, Toronto (CA)

(73) Assignee: RESEARCH IN MOTION LIMITED, Waterloo (CA)

(21) Appl. No.: 13/616,970

(22) Filed: Sep. 14, 2012

(51) Int. Cl. H04R 1/02

(52) U.S. Cl. CPC H04R 1/026
USPC 381/334

(57) ABSTRACT

A speaker comprises a housing that defines an internal cavity within which a sound generating member is disposed. The housing includes a front panel and a rear panel and defines a base. The rear panel includes a kickstand configured to extend from the rear panel in a deployed position and, together with the base, to support the speaker housing in an upright, leaning orientation. The speaker comprises an electrical connector disposed between the kickstand and the rear panel. The electrical connector is configured for coupling an external source of electrical power to the speaker. Front panels of first and second speakers define front surfaces configured to facilitate positioning of the first speaker and the second speaker in a face-to-face mating arrangement. Each of the first speaker and the second speaker comprises magnetic elements disposed for retaining the first speaker and the second speaker in the face-to-face mating arrangement.

### BACKGROUND

In today's world, portable speakers are becoming increasingly popular for enhancing the listening experience associated with other portable electronic devices such as cell phones and smart phones. In addition to the benefits of portable speakers, however, a number of problems have emerged. These include the potential for damage to the speakers due to infiltration of contaminants through not only the areas designed for emitting sound but also through the electrical connector that facilitates connecting the speaker to a power source or to a source of content for driving the sound produced by the speaker.

In addition to problems associated with damage occurring to portable speakers, experience has shown that sound emissions that are configured for listening in one environment, such as when conducting a conference call via a cell phone, may not be appropriate or desirable for listening in a different environment, such as when listening to music being played through the speaker.

Accordingly, it is desirable to have a portable speaker that provides improved protection from damage during transportation and/or storage of the speaker. It is also desirable to have a portable speaker that can automatically accommodate different listening modes.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is drawing showing a perspective view of an exemplary speaker with a kickstand in a deployed position;

FIG. 2 is drawing of showing a side view of an exemplary speaker with a kickstand in a deployed position and the speaker in a standing orientation;

FIG. 3 is drawing showing perspective view of an exemplary pair of speakers positioned in a face-to-face mating arrangement showing a kickstand in a stored position; and

FIG. 4 is drawing showing a front view of an exemplary pair of speakers.

### DETAILED DESCRIPTION

It should be understood at the outset that although illustrative implementations of one or more embodiments of the present disclosure are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

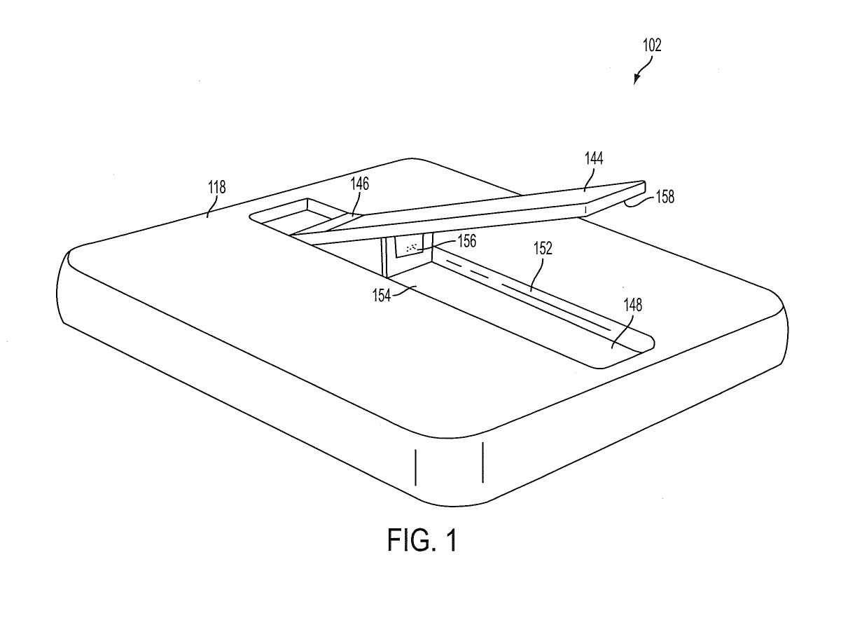

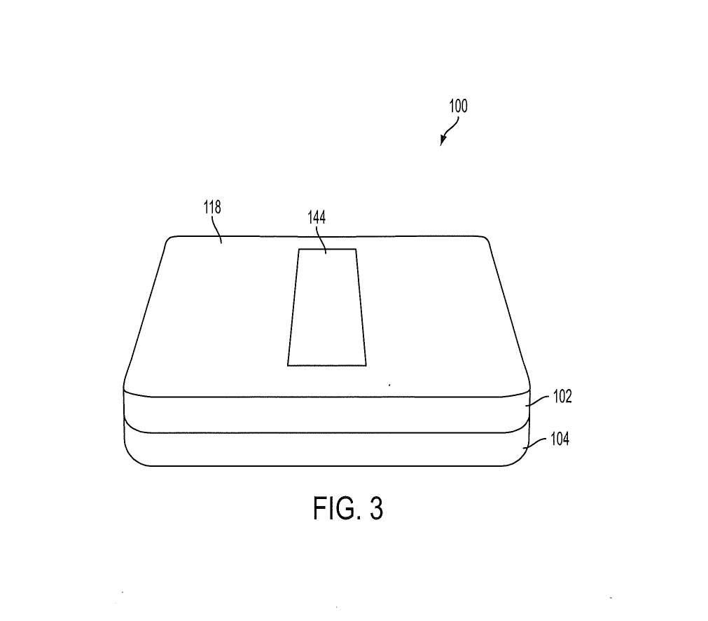

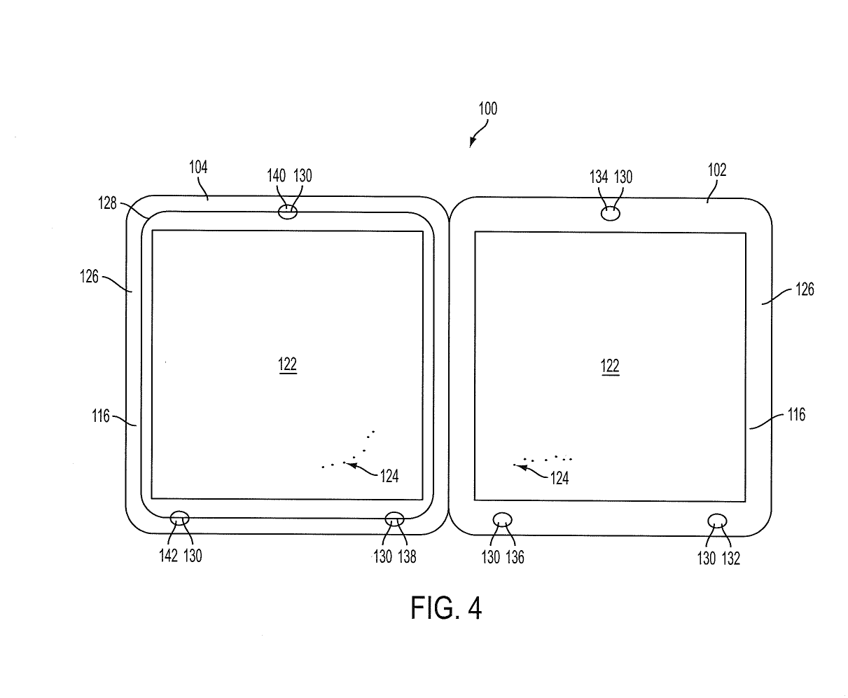

As shown in FIGS. 3-4, a pair of speakers 100 includes a first speaker 102 and a second speaker 104. As shown in FIGS. 1-4, each speaker 102, 104 comprises a housing 106 that defines an internal cavity 108, within which a sound generating member (i.e., a vibrating member) 110 is disposed. An actuator 112 is positioned for cooperation with (e.g., adjacent to) the sound generating member 110 and is configured for causing the sound generating member 110 to vibrate, and to thereby generate sound waves, in response to instructions provided by a controller 114. Accordingly, the actuator 112, the sound generating member 110, and the controller 114 are coupled (e.g., mechanically coupled, magnetically coupled, pneumatically coupled, hydraulically coupled, or electrically coupled) to one another, and configured for cooperation with one another, such that the sound generating member 110 produces sound waves substantially as instructed by the controller 114.

It should be appreciated that the terms configured for and configured to refer to a condition wherein the element or feature that is so configured is capable of performing the designated function even if the element or feature does not necessarily perform the designated function at all times. For example, it should be appreciated from the foregoing description of the actuator 112, that the actuator 112 is capable of causing the sound generating member 110 to vibrate, and to thereby generate sound waves, in response to instructions provided by the controller 114. Moreover, it should be appreciated that the actuator 112 is capable of causing the sound generating member 110 to vibrate, and to thereby generate sound waves, in response to instructions provided by the controller 114 even if the actuator 112 does not necessarily causing the sound generating member 110 to vibrate, and to thereby generate sound waves at all times.

In an exemplary embodiment, the housing 106 is substantially rigid and impervious to infiltration of foreign matter so as to provide a protected environment for the speaker elements disposed within the internal cavity 108. The housing 106 includes a front panel 116 and a rear panel 118 and defines a base surface 120. The front panel 116 includes a sound-emitting portion 122 configured to permit (i.e., is capable of permitting) transmission of sound waves generated by the sound generating member 110 as it vibrates. In an exemplary embodiment, the sound-emitting portion 122 defines a plurality (e.g., hundreds) of perforations 124 that are laser drilled through the sound emitting portion 122 of the front panel 116.

In an exemplary embodiment, the front panel 116 defines a front surface 126 that is configured to facilitate (i.e., is capable of facilitating) face-to-face mating between a first speaker 102 and a second speaker 104 (i.e., positioning of the first speaker and the second speaker in a face-to-face mating arrangement). For example, in one exemplary embodiment, a front surface 126 of a first speaker 102 is planar so as to facilitate face-to-face mating with a planar front surface 126 of a second speaker 104. In an alternative embodiment, a front surface 126 of a first speaker 102 includes a concavity or other shape that is complementary to a convexity or other shape of a front surface 126 of a second speaker 104.

In an exemplary embodiment, a seal 128 (e.g., a resilient member configured for, i.e., capable of, providing a barrier to infiltration of foreign substances when contacting a mating surface) is disposed on front surface 126 such that when a first speaker 102 is mated face-to-face with a second speaker 104, the sound-emitting portion 122 is protected from infiltration of foreign substances such as dirt and moisture.

In an exemplary embodiment, a first speaker 102 includes one or more magnetic element 130 disposed within the housing 106 for retaining the first speaker 102 in a face-to-face mating relationship with a second speaker 104. For example, a first speaker 102 includes a first magnetic element 132, a second magnetic element 134, and a third magnetic element 136. Correspondingly, a second speaker 104 includes a fourth magnetic element 138, a fifth magnetic element 140, and a sixth magnetic element 142. Fourth magnetic element 138 is disposed so as to be in close proximity to the first magnetic element 132 when the first speaker 102 is in a face-to-face mating relationship with the second speaker 104. Similarly, the fifth magnetic element 140 is disposed so as to be in close proximity to the second magnetic element 134, and the sixth magnetic element 142 is disposed so as to be in close proximity to the second magnetic element 134, when the first speaker 102 is in a face-to-face mating relationship with the second speaker 104.

In addition to being placed in close proximity with one another upon face-to-face mating of first speaker 102 with second speaker 104, corresponding pairs of magnetic elements 130 are configured to result in the imposition of an attractive force (i.e., are capable of imposing an attractive force) between the mating magnetic elements of the first speaker 102 and the second speaker 104. More specifically, where the first magnetic element 132 is a magnet having a first magnetic polarity, the fourth magnetic element 138, which mates with the first magnetic element 132, may comprise either a magnet having a second magnetic polarity that is opposite the first magnetic polarity (and is thus suitable for imposing an attractive force between the first magnetic element 132 and the fourth magnetic element 138) or a material that interacts in an attractive manner with a magnetic material (e.g., a material comprising iron).

It should be appreciated that any number of complementary magnetic elements may be disposed among first speaker 102 and second speaker 104 so as to facilitate retention of first speaker 102 and second speaker 104 in face-to-face mating relationship. It should also be appreciated that pairs of complementary magnetic elements 130 may be arranged among first speaker 102 and second speaker 104 so as to result in imposition of an attractive force between adjacent magnetic elements 130 when the first speaker 102 and second speaker 104 are mated in a preferred orientation, while resulting in a repulsive force between adjacent magnetic elements 130 when the first speaker 102 and second speaker 104 are mated in an orientation other than a preferred orientation. A preferred orientation, for example, may be an orientation in which an advantageous sealing condition is accomplished between seals 128 disposed on front surfaces 126 of the first speaker 102 and the second speaker 104.

In an exemplary embodiment, the rear panel 118 includes a kickstand 144 that is configured to extend (i.e., is capable of extending) from a support point 146 on the rear panel 118 and, together with the base surface 120, support the first speaker 102 in a desired orientation for listening. For example, a desired orientation for listening may be characterized by a positioning of the sound emitting portion 122 at an angle approximately 30 degrees from vertical. As used herein the term vertical refers to a direction that substantially opposes gravity, and the term horizontal refers to a direction that is substantially perpendicular to the force of gravity. Thus, where the sound emitting portion 122 is positioned at an angle approximately 30 degrees from vertical, a vector that is perpendicular to the sound emitting portion 122 forms an angle that is approximately 30 degrees from (e.g., above) a horizontal direction.

Supported by the base surface 120 and the kickstand 144, with the sound emitting portion 122 being positioned at an angle approximately 30 degrees from vertical, the first speaker 102 may be said to be in an upright, leaning orientation. It should be appreciated that the choice of 30 degrees in this description is for illustration purposes only and that an upright, leaning orientation refers to orientations of the sound emitting portion 122 at various angles from vertical such as 5 degrees, 10 degrees, 15 degrees, 20 degrees, 25 degrees, 35 degrees, 40 degrees, 45 degrees, 60 degrees, and the like. Thus, as used herein, the term upright, leaning orientation refers to orientations of the first speaker 102 wherein the first speaker 102 is supported by both the base surface 120 and the kickstand 144 such that the sound emitting portion 122 is oriented at an angle relative to the horizontal direction.

The rear panel 118 may define a kickstand pocket 148 into which the kickstand 144 may fold for compact storage. To facilitate deployment of the kickstand 144 from its stored position (as shown in FIG. 3) to its deployed position (as shown in FIG. 1), the support point 146 may be configured to provide (i.e., may be capable of providing) a kickstand fulcrum 150 for facilitating pivoting movement between the kickstand 144 and the rear panel 118. For example, the kickstand 144 may be attached to the rear panel 118 via a hinge providing a limited range of rotation, or the kickstand may comprise a pair of posts extending into a pair of complementary holes defined in the rear panel 118.

In an exemplary embodiment, the rear panel 118 defines a kickstand seal 152 configured for cooperating (i.e., capable of cooperating) with the kickstand 144 to provide a protected region 154 within the kickstand pocket 148 from infiltration of contamination such as dirt, dust, or moisture when the kickstand 144 is folded for storage in or against the kickstand pocket 148 (i.e., in its stored position).

In an exemplary embodiment, an electrical connector 156 is disposed between the kickstand 144 and the kickstand pocket 148 (e.g., along an internal side 158 of the kickstand 144) such that, when the kickstand 144 is in its stored position, the electrical connector 156 is positioned within the protected region 154. Even though it is disposed along an internal side 158 of the kickstand 144, the electrical connector 156 is also is exposed for interfacing with a mating electrical connector (not shown) when the kickstand 144 is in its deployed position. In an exemplary embodiment, the electrical connector 156 is configured for mating (i.e., capable of mating) with a standard micro USB connector and may be configured for providing (i.e., may be capable of providing) transmission of information between the first speaker 102 and another external component and/or for providing a supply of electrical power for driving the actuator 112 or for storage within a power storage device 160 of the first speaker 102. Thus, the electrical connector 156 is configured for coupling (i.e., is capable for coupling) an external source (not shown) of electrical power and/or information to the first speaker 102.

In an exemplary embodiment, a first speaker 102 includes a receiver 162 for receiving information from an external source (not shown). The information may be configured to define (i.e., is suitable for defining) the sounds to be transmitted by the first speaker 102 and/or logic to be used by the first speaker 102 in processing other information. The information may be transmitted to the receiver 162 wirelessly (e.g., via Bluetooth) or via a wired connection via the electrical connector 156. The receiver 162 is in communication with the controller 114, which comprises a processor 164 in communication with a memory storage device 166. Information received by the receiver 162 may be stored in the memory storage device 166 and/or processed by the processor 164 as necessary to facilitate the controller 114 providing instructions to the actuator 112, causing the sound generating member 110 to vibrate, thereby generating sound waves.

In an exemplary embodiment, the first speaker 102 and the second speaker 104 each include a plurality of electrical connectors 156. The electrical connectors may be distributed about the exterior surfaces of the speaker 102 for easy access or may be grouped within the protected region 154. In an exemplary embodiment, the receiver 162 is configured for receiving (i.e., is capable of receiving) information from an external source via any one of the electrical connectors 156. To facilitate the incorporation of multiple electrical connectors 156 (and/or to prevent conflicts from occurring between signals or power received or sent between two or more of the electrical connectors 156), the controller 114 may be configured to control (i.e., is capable of controlling) the processing of power and/or information received from the individual electrical connectors 156.

For example, where a sensor indicates that a particular electrical connector 156 is coupled (e.g., electrically or magnetically coupled) to an external source of power or signal transmissions, the controller 114 may be configured to activate (i.e., is capable of activating) that particular electrical connector 156 and de-activate other electrical connectors. Further, where connections exist between external sources of power and/or information (i.e., signals) and two or more electrical connectors 156, the controller 114 may be configured to transmit (i.e., is capable of transmitting) power and/or to process signals from only one of the electrical connectors 156 at a time. The controller 114 may determine which electrical connector 156 to use at a particular time based on a user-prescribed preference or based on logic. An indication of whether an electrical connector 156 is active or inactive may be provided, such as via an external display or an illuminated LED (e.g., a green LED indicating an active connector/connection and a red LED indicating an inactive connector/connection).

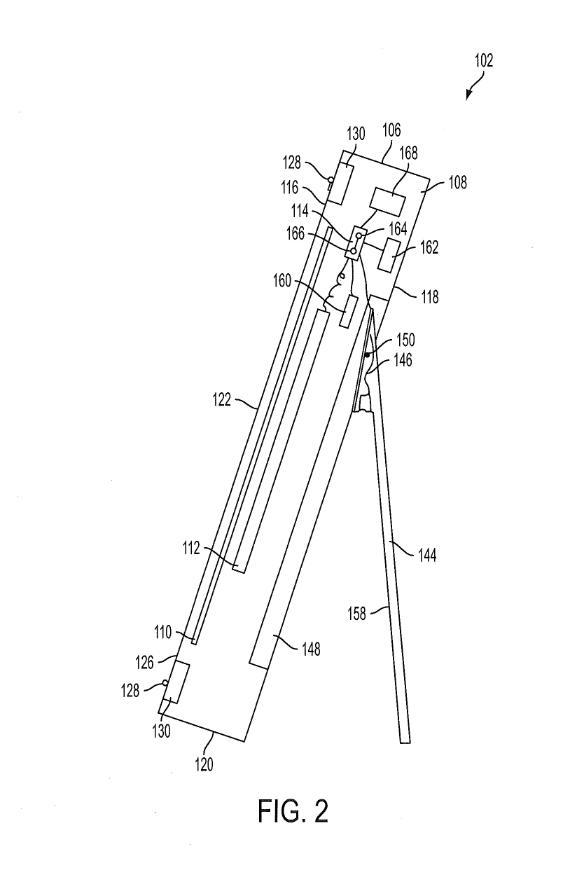

The controller 114 may also be in communication with one or more sensors 168 for detecting one or more operational conditions of the first speaker 102. In an exemplary embodiment, a sensor 168 is configured for detecting (is capable of detecting) when the first speaker 102 is in a desired orientation, such as a desired orientation for listening to music (e.g., an upright, leaning orientation as shown in FIG. 2) or a desired orientation for operating in teleconference mode (e.g., lying on the rear panel 118), and for sending a signal to the controller 114 indicative of that detected orientation. In another exemplary embodiment, a sensor 168 may be configured for detecting (i.e., is capable of detecting) when the first speaker 102 is in a mated arrangement with another second speaker 104, such as a face-to-face mating arrangement, and for sending a signal to the controller 114 indicative of that detected orientation. In response to receipt of such orientation signals, the controller 114 may process the information received according to appropriate logic stored in memory storage device 166 so as to produce sound waves configured according to the detected orientation of the first speaker 102 or to block production of sound waves altogether when the speaker is in a face-to-face mating arrangement. Thus, the first speaker 102 is configured for emitting (i.e., capable of emitting) sounds (or not) in accordance with signals received by the speaker 102, 104 and one or more sensed conditions of the speaker 102, 104.

Thus, in an exemplary embodiment, a speaker 102, 104 comprises a housing 106 that defines an internal cavity 108 within which a sound generating member 110 is disposed. The housing 106 includes a front panel 116 and a rear panel 118, and defines a base 120. The front panel includes a sound-emitting portion 122 configured to permit (i.e., capable of permitting) transmission of sound waves generated by the sound generating member 110. The rear panel 118 includes a kickstand 144 configured to extend (i.e., capable of extending) from the rear panel 118 in a deployed position and, together with the base 120, to support the speaker housing 106 in an upright, leaning orientation. The speaker 102, 104 further comprises an electrical connector 156 disposed between the kickstand 144 and the rear panel 118, and the electrical connector 156 is configured for coupling (i.e., capable of coupling) an external source of electrical power to the speaker 102, 104.

In another aspect, an exemplary pair of speakers 102, 104 comprises a first speaker 102 and a second speaker 104, wherein each of the first speaker 102 and the second speaker 104 comprises a housing 106 that defines an internal cavity 108 within which a sound generating member 110 is disposed. Each respective housing 106 of the first speaker 102 and the second speaker 104 includes a front panel 116 and a rear panel 118 and defines a base 120. Each respective front panel 116 of the first speaker 102 and the second speaker 104 includes a sound-emitting portion 122 configured to permit (i.e., capable of permitting) transmission of sound waves generated by the respective sound generating member 110 of each of the first speaker 102 and the second speaker 104. Each respective front panel 116 of the first speaker 102 and the second speaker 104 defines a respective front surface 126 that is configured to facilitate (i.e., capable of facilitating) positioning of the first speaker 102 and the second speaker 104 in a face-to-face mating arrangement, and each of the first speaker 102 and the second speaker 104 comprises one or more magnetic elements 130 disposed within the respective housing 106 for retaining the first speaker 102 and the second speaker 104 in the face-to-face mating arrangement.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A speaker comprising:
a housing that defines an internal cavity within which a sound generating member is disposed;
the housing including a front panel and a rear panel and defining a base;
the front panel including a sound-emitting portion configured to permit transmission of sound waves generated by the sound generating member;
the rear panel including a kickstand configured to extend from the rear panel in a deployed position and, together with the base, to support the housing in an upright, leaning orientation;
further comprising an electrical connector disposed between the kickstand and the rear panel, the electrical connector configured for coupling an external source of electrical power to the speaker.

2. A speaker as described in claim 1, wherein the rear panel defines a kickstand pocket into which the kickstand may reside when in a stored position.

3. A speaker as described in claim 2, wherein the kickstand is configured to pivot about a fulcrum defined by the rear panel between the stored position and the deployed position.

4. A speaker as described in claim 2, the rear panel defining a kickstand seal configured for providing a protected region within the kickstand pocket when the kickstand is in the stored position.

5. A speaker as described in claim 1, wherein the electrical connector is disposed along an internal side of the kickstand.

6. A speaker as described in claim 2, wherein, when the kickstand is in the stored position, the electrical connector is positioned within the kickstand pocket.

7. A speaker as described in claim 4, wherein, when the kickstand is in the stored position, the electrical connector is positioned within the protected region.

8. A speaker as described in claim 1, wherein, when the kickstand is in the deployed position, the electrical connector is exposed for interfacing with a mating electrical connector.

9. A speaker as described in claim 1, wherein the electrical connector is configured for mating with a micro USB connector.

10. A speaker as described in claim 1, wherein the electrical connector is configured for coupling an external source of electrical power to the speaker.

11. A speaker as described in claim 1, further comprising:
a controller in communication with a sensor;
the sensor being configured for detecting an operational condition of the speaker;
the controller being configured for affecting sound waves generated by the sound generating member based at least in part on the operational condition of the speaker.

12. A speaker as described in claim 11, wherein the sensor is configured for detecting when the speaker is in a desired orientation.

13. A pair of speakers comprising:
a first speaker and a second speaker;
wherein each of the first speaker and the second speaker comprises a housing that defines an internal cavity within which a sound generating member is disposed;
wherein each respective housing of the first speaker and the second speaker includes a front panel and a rear panel and defines a base;
wherein each respective front panel of the first speaker and the second speaker includes a sound-emitting portion configured to permit transmission of sound waves generated by the respective sound generating member of each of the first speaker and the second speaker;
wherein each respective front panel of the first speaker and the second speaker defines a respective front surface that is configured to facilitate positioning of the first speaker and the second speaker in a face-to-face mating arrangement; and
wherein each of the first speaker and the second speaker comprises one or more magnetic elements disposed within the respective housing for retaining the first speaker and the second speaker in the face-to-face mating arrangement.

14. The pair of speakers as described in claim 13, wherein the front surface of the first speaker is planar and the front surface of the second speaker is planar.

15. The pair of speakers as described in claim 13, wherein a seal is disposed on the front surface of the first speaker, the seal being configured for protecting each respective sound-emitting portion of the first speaker and the second speaker from infiltration of foreign substances when the first speaker and the second speaker are positioned in the face-to-face mating arrangement.

16. The pair of speakers as described in claim 13, wherein at least one of the one or more magnetic elements of the first speaker is disposed so as to be in close proximity to a corresponding magnetic element of the second speaker when the first speaker is in a face-to-face mating relationship with the second speaker.

17. The pair of speakers as described in claim 16, wherein the at least one of the one or more magnetic elements of the first speaker is configured as a magnet having a first magnetic polarity and wherein the corresponding magnetic element of the second speaker is configured to result in imposition of an attractive force between the at least one of the one or more magnetic elements of the first speaker and the corresponding magnetic element of the second speaker when the first speaker is in a face-to-face mating relationship with the second speaker.

18. The pair of speakers as described in claim 13, wherein each of the first speaker and the second speaker comprises one or more magnetic elements disposed within the respective housing for imposing a repulsive force between the first speaker and the second speaker when the first speaker and the second speaker are positioned in the face-to-face mating arrangement in an orientation other than a preferred orientation.

19. The pair of speakers as described in claim 13:
wherein each of the first speaker and the second speaker further comprises a controller in communication with a sensor;
wherein each sensor is configured for detecting when the respective speaker is positioned in the face-to-face mating arrangement;
wherein each controller is configured for affecting sound waves generated by the respective sound generating member when the respective speaker is positioned in the face-to-face mating arrangement.

20. A pair of speakers as described in claim 13:
wherein the rear panel of each speaker includes a kickstand configured to extend from the rear panel in a deployed position and, together with the base, to support the housing in an upright, leaning orientation;
each speaker further comprising an electrical connector disposed between the kickstand and the rear panel, the electrical connector configured for coupling an external source of electrical power to the speaker.
